(19) United States
(12) Patent Application Publication
(10) Pub. No.: US 2016/0277143 A1
(43) Pub. Date: Sep. 22, 2016

(54) TRANSMISSION MODE SWITCHING METHOD AND DEVICE

(71) Applicant: Huawei Technologies Co., Ltd., Shenzhen (CN)

(72) Inventors: Wenquan Hu, Shanghai (CN); Weijie Zhao, Shanghai (CN); Meng Hua, Shanghai (CN)

(21) Appl. No.: 15/165,382

(22) Filed: May 26, 2016

Related U.S. Application Data
(63) Continuation of application No. PCT/CN2014/092278, filed on Nov. 26, 2014.

(30) Foreign Application Priority Data
Nov. 26, 2013 (CN) 201310608605.4

(51) Int. Cl. H04L 1/00; H04W 72/04; H04W 24/08

(52) U.S. Cl. CPC H04L 1/0025; H04W 24/08; H04W 72/0406

(57) ABSTRACT

Embodiments of the present invention provide a transmission mode switching method and a device. The method includes: monitoring, by user equipment UE, pilot signals sent by at least two nodes, where the pilot signals sent by the different nodes are different, and the pilot signals are used for differentiating the at least two nodes; and sending, by the UE, a physical layer measurement result report to a base station (NodeB) if the UE determines, according to the detected pilot signals, that measurement results of the pilot signals of the at least two nodes meet a preset trigger condition, so that the base station performs downlink transmission mode switching. In this way, a latency for downlink transmission mode switching is reduced.

### CROSS-REFERENCE TO RELATED APPLICATIONS

This application is a continuation of International Application No. PCT/CN2014/092278, filed on Nov. 26, 2014, which claims priority to Chinese Patent Application No. 201310608605.4, filed on Nov. 26, 2013, both of which are incorporated herein by reference in their entireties.

### TECHNICAL FIELD

Embodiments of the present invention relate communications technology, and in particular, to a transmission mode switching method and a device.

### BACKGROUND

In a universal mobile telecommunications system (Universal Mobile Telecommunications System, UMTS for short), a combined cell is a logical cell to which cells corresponding to multiple coverage areas belong. When user equipment (User Equipment, UE for short) moves in the different coverage areas, higher layer signaling exchange does not occur, and transceiver nodes in the combined cell send a primary common pilot channel by using a same scrambling code.

The combined cell generally includes a high power node (High Power Node, HPN for short) and a low power node (Low Power Node, LPN for short), and the nodes are connected to a central processor of the nodes by using low latency links. According to different locations of the UE, there are three transmission modes in the combined cell: Mode (Mode) 1 is node selection, mode 2 is beamforming, and mode 3 is multiplexing. Mode 1 is applicable to a scenario in which a strength of a received downlink signal of a node is much greater than a strength of a received signal of another node, and mode 2 and mode 3 are applicable to a scenario in which received downlink signals of different nodes are of about a same strength.

In different scenarios, the central processor needs to determine which mode should be used in the combined cell to send downlink data for the UE. In the prior art, during mode switching, resource reconfiguration needs to be completed by using higher layer signaling. Much signaling is exchanged in the switching process, leading to a relatively long switching latency.

### SUMMARY

Embodiments of the present invention provide a transmission mode switching method and a device to reduce a latency for downlink transmission mode switching.

According to a first aspect, an embodiment of the present invention provides a transmission mode switching method, including:

monitoring, by user equipment UE, pilot signals sent by at least two nodes, where the pilot signals sent by the different nodes are different, and the pilot signals are used for differentiating the at least two nodes; and

sending, by the UE, a physical layer measurement result report to a base station (NodeB) if the UE determines, according to the detected pilot signals, that measurement results of the pilot signals of the at least two nodes meet a preset trigger condition, so that the NodeB performs downlink transmission mode switching.

In a first possible implementation manner of the first aspect, after the sending, by the UE, a physical layer measurement result report to a NodeB if the UE determines, according to the detected pilot signals, that measurement results of the pilot signals of the at least two nodes meet a preset trigger condition, the method further includes:

receiving, by the UE, a mode switching indication that is sent by the NodeB by using a downlink high speed-shared control channel HS-SCCH, where the mode switching indication includes information about a downlink transmission mode.

According to the first possible implementation manner of the first aspect, in a second possible implementation manner, the mode switching indication further includes information about a node that sends downlink data.

With reference to the first aspect to the second possible implementation manner of the first aspect, in a third possible implementation manner, the preset trigger condition is: the UE detects that a parameter value of the pilot signals sent by the at least two nodes falls within a preset threshold range; or the UE detects that a parameter value of the pilot signals sent by the at least two nodes falls beyond a preset threshold range.

According to the third possible implementation manner of the first aspect, in a fourth possible implementation manner, the parameter value of the pilot signals is any one of the following: a strength difference of the pilot signals, a channel quality difference, and a path gain difference.

With reference to the first aspect to the fourth possible implementation manner of the first aspect, in a fifth possible implementation manner, the at least two nodes send the pilot signals in at least one of the following manners: different timeslots, different scrambling codes, and different channelization codes.

In a sixth possible implementation manner of the first aspect, the physical layer measurement result report includes at least one of the following information: information about a channel quality indicator, information about a path gain, information about the received energy per chip divided by the power density in the band (Ec/No), and information about a received signal code power.

According to a second aspect, an embodiment of the present invention provides a transmission mode switching method, including:

receiving, by a base station (NodeB), a physical layer measurement result report sent by user equipment UE, where the physical layer measurement result report is sent by the UE to the NodeB when the UE determines that measurement results of signals of at least two nodes meet a preset trigger condition; and

performing, by the NodeB, downlink transmission mode switching according to the physical layer measurement result report.

In a first possible implementation manner of the second aspect, after the performing, by the NodeB, transmission mode switching according to the physical layer measurement result report, the method further includes:

sending, by the NodeB, a mode switching indication to the UE by using a downlink high speed-shared control channel HS-SCCH, where the mode switching indication is used for indicating to the UE that downlink transmission enters a different transmission mode; and the mode switching indication includes information about a downlink transmission mode.

According to the first possible implementation manner of the second aspect, in a second possible implementation manner, the mode switching indication further includes information about a node that sends downlink data.

With reference to the second aspect to the second possible implementation manner of the second aspect, in a third possible implementation manner, the physical layer measurement result report includes at least one of the following information: information about a channel quality indicator, information about a path gain, information about the received energy per chip divided by the power density in the band (Ec/No), and information about a received signal code power.

According to a third aspect, an embodiment of the present invention provides user equipment UE, including:

a monitoring module, configured to monitor pilot signals sent by at least two nodes, where the pilot signals sent by the different nodes are different, and the pilot signals are used for differentiating the at least two nodes; and

a sending module, configured to send a physical layer measurement result report to a base station (NodeB) if the UE determines, according to the detected pilot signals, that measurement results of the pilot signals of the at least two nodes meet a preset trigger condition, so that the NodeB performs downlink transmission mode switching.

In a first possible implementation manner of the third aspect, the UE further includes a receiving module, configured to receive a mode switching indication that is sent by the NodeB by using a downlink high speed-shared control channel HS-SCCH, where the mode switching indication includes information about a downlink transmission mode.

According to the first possible implementation manner of the third aspect, in a second possible implementation manner, the mode switching indication further includes information about a node that sends downlink data.

With reference to the third aspect to the second possible implementation manner of the third aspect, in a third possible implementation manner, the preset trigger condition is: the UE detects that a parameter value of the pilot signals sent by the at least two nodes falls within a preset threshold range; or the UE detects that a parameter value of the pilot signals sent by the at least two nodes falls beyond a preset threshold range.

According to the third possible implementation manner of the third aspect, in a fourth possible implementation manner, the parameter value of the pilot signals is any one of the following: a strength difference of the pilot signals, a channel quality difference, and a path gain difference.

With reference to the third aspect to the fourth possible implementation manner of the third aspect, in a fifth possible implementation manner, the at least two nodes send the pilot signals in at least one of the following manners: different timeslots, different scrambling codes, and different channelization codes.

In a sixth possible implementation manner of the third aspect, the physical layer measurement result report includes at least one of the following information: information about a channel quality indicator, information about a path gain, information about the received energy per chip divided by the power density in the band (Ec/No), and information about a received signal code power.

According to a fourth aspect, an embodiment of the present invention provides a base station (NodeB), including:

a receiving module, configured to receive a physical layer measurement result report sent by user equipment UE, where the physical layer measurement result report is sent by the UE to the NodeB when the UE determines that measurement results of signals of at least two nodes meet a preset trigger condition; and

a processing module, configured to perform downlink transmission mode switching according to the physical layer measurement result report.

In a first possible implementation manner of the fourth aspect, the NodeB further includes a sending module, configured to send a mode switching indication to the UE by using a downlink high speed-shared control channel HS-SCCH, where the mode switching indication is used for indicating to the UE that downlink transmission enters a different transmission mode; and the mode switching indication includes information about a downlink transmission mode.

According to the first possible implementation manner of the fourth aspect, in a second possible implementation manner, the mode switching indication further includes information about a node that sends downlink data.

With reference to the fourth aspect to the second possible implementation manner of the fourth aspect, in a third possible implementation manner, the physical layer measurement result report includes at least one of the following information: information about a channel quality indicator, information about a path gain, information about the received energy per chip divided by the power density in the band (Ec/No), and information about a received signal code power.

In the transmission mode switching method and the device provided in the embodiments of the present invention, UE monitors pilot signals sent by at least two nodes, where the pilot signals sent by the different nodes are different, and the pilot signals are used for differentiating the at least two nodes; and the UE sends a physical layer measurement result report to a base station (NodeB) if the UE determines, according to the detected pilot signals, that measurement results of the pilot signals of the at least two nodes meet a preset trigger condition, so that the NodeB performs downlink transmission mode switching. In this way, a latency for downlink transmission mode switching is reduced.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a flowchart of Embodiment 1 of a transmission mode switching method according to the present invention;

FIG. 2 is a flowchart of Embodiment 2 of a transmission mode switching method according to the present invention;

FIG. 3 is a schematic structural diagram of an embodiment of UE according to the present invention; and

FIG. 4 is a schematic structural diagram of an embodiment of a NodeB according to the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

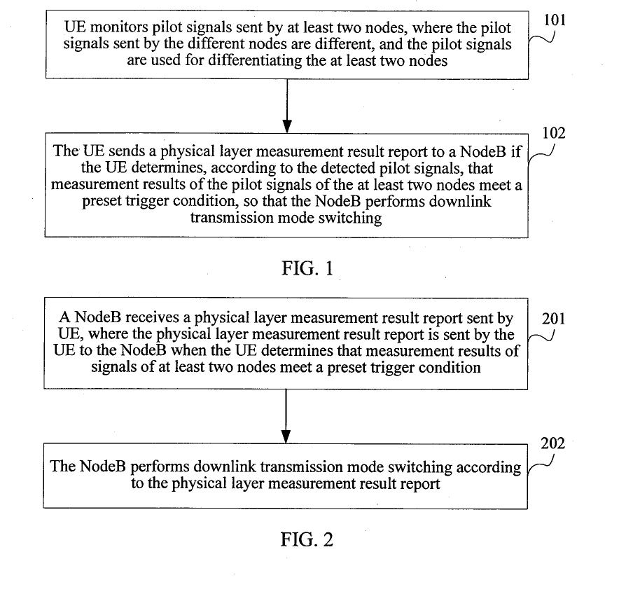

FIG. 1 is a flowchart of Embodiment 1 of a transmission mode switching method according to the present invention. As shown in FIG. 1, the method provided in this embodiment may be specifically executed by user equipment, and the method provided in this embodiment may specifically include:

Step 101: The UE monitors pilot signals sent by at least two nodes, where the pilot signals sent by the different nodes are different, and the pilot signals are used for differentiating the at least two nodes.

Specifically, the at least two nodes send the pilot signals in at least one of the following manners: different timeslots, different scrambling codes, and different channelization codes. For example, different nodes may construct different pilot signals by using different timeslots, or may construct different pilot signals by using different scrambling codes, or may construct different pilot signals by using different channelization codes, or may use any combination of the foregoing manners, which is not limited in this embodiment.

Step 102: The UE sends a physical layer measurement result report to a NodeB if the UE determines, according to the detected pilot signals, that measurement results of the pilot signals of the at least two nodes meet a preset trigger condition, so that the NodeB performs downlink transmission mode switching.

It should be noted that the preset trigger condition may be: the UE detects that a parameter value of the pilot signals sent by the at least two nodes falls within a preset threshold range; or the preset trigger condition may be: the UE detects that a parameter value of the pilot signals sent by the at least two nodes falls beyond a preset threshold range. The parameter value of the pilot signals is any one of the following: a strength difference of the pilot signals, a channel quality difference, and a path gain difference, which is not limited in this embodiment.

For example, if the UE detects that a strength difference between a strength of a downlink pilot signal of an LPN and a strength of a downlink pilot signal of an HPN falls within or falls beyond a preset threshold range [−3 dB, 3 dB], the UE triggers reporting physical layer measurement results, that is, sends the physical layer measurement result report to the NodeB. Optionally, the physical layer measurement result report includes at least one of the following information: information about a channel quality indicator (Channel Quality Indicator, CQI for short), information about a path gain (Path Gain), information about a ratio of a chip power to a noise power (Ec/No), and information about a received signal code power (Received Signal Code Power, RSCP for short), which is not limited in this embodiment.

In actual application, further, if the UE uses a closed loop transmit diversity (Closed Loop Transmit Diversity, CLTD for short) in mode 2, after the UE sends the physical layer measurement result report to the NodeB, the UE may further receive a mode switching indication that is sent by the NodeB by using a downlink high speed-shared control channel (High Speed-Shared Control Channel, HS-SCCH for short), where the mode switching indication includes information about a downlink transmission mode. Optionally, the mode switching indication may further include information about a node that sends downlink data.

It should be noted that if a receiver capability of the UE is supporting only mode 1 and mode 2, and in mode 2, the UE uses an open loop transmit diversity (Open Loop Transmit Diversity, OLTD for short), in this case, the UE does not need to know which transmission mode is used on a network side, and therefore the NodeB does not need to send the mode switching indication to the UE.

In the technical solution in this embodiment, UE monitors pilot signals sent by at least two nodes, where the pilot signals sent by the different nodes are different, and the pilot signals are used for differentiating the at least two nodes; and the UE sends a physical layer measurement result report to a NodeB if the UE determines, according to the detected pilot signals, that measurement results of the pilot signals of the at least two nodes meet a preset trigger condition, so that the NodeB performs downlink transmission mode switching. In this way, a latency for downlink transmission mode switching is reduced.

FIG. 2 is a flowchart of Embodiment 2 of a transmission mode switching method according to the present invention. As shown in FIG. 2, the method provided in this embodiment may be specifically executed by a NodeB, and the method provided in this embodiment may specifically include:

Step 201: The NodeB receives a physical layer measurement result report sent by UE, where the physical layer measurement result report is sent by the UE to the NodeB when the UE determines that measurement results of signals of at least two nodes meet a preset trigger condition.

In this step, the physical layer measurement result report includes at least one of the following information: information about a channel quality indicator, information about a path gain, information about Ec/No, and information about a received signal code power.

Step 202: The NodeB performs downlink transmission mode switching according to the physical layer measurement result report.

In actual application, if the UE uses a CLTD in mode 2, after the NodeB performs downlink transmission mode switching, the NodeB further needs to send a mode switching indication to the UE by using an HS-SCCH, where the mode switching indication is used for indicating to the UE that downlink transmission enters a different transmission mode, and the mode switching indication includes information about a downlink transmission mode. Optionally, the mode switching indication may further include information about a node that sends downlink data.

In the technical solution in this embodiment, a NodeB receives a physical layer measurement result report sent by user equipment UE, where the physical layer measurement result report is sent by the UE to the NodeB when the UE determines that measurement results of signals of at least two nodes meet a preset trigger condition; and the NodeB performs downlink transmission mode switching according to the physical layer measurement result report. In this way, a latency for downlink transmission mode switching is reduced.

In the method for transmission mode switching provided in this embodiment, a process of performing downlink transmission mode switching is:

The UE continuously monitors pilot signals sent by different nodes. To differentiate different nodes, the nodes need to use different pilot signals, for example, construct different pilot signals by using different timeslots, and/or construct different pilot signals by using different scrambling codes, and/or construct different pilot signals by using different channelization codes to implement differentiation. Specifically, by monitoring pilot signals sent by different nodes, the UE may obtain measurement results shown in Table 1.

TABLE 1
Measurement result

| Identification of | |
|---|---|
| node | Measurement result |
| 0 | RSCP0(Ec/No, Path Gain, CQI) |
| 1 | RSCP1(Ec/No, Path Gain, CQI) |
| 2 | RSCP2(Ec/No, Path Gain, CQI) |
| 3 | RSCP3(Ec/No, Path Gain, CQI) |

When the UE detects that a parameter value of the pilot signals falls within or falls beyond a preset threshold range, for example, a strength difference between a strength of a downlink pilot signal of an LPN received by the UE and a strength of a downlink pilot signal of an HPN received by the UE falls within or falls beyond [−3 dB, 3 dB], the UE triggers reporting physical layer measurement results, that is, the UE sends the physical layer measurement result report to the NodeB. Optionally, the physical layer measurement result report may include information about a CQI, and/or information about a path gain, and/or information about an Ec/No, and/or information about an RSCP, which is not limited in this embodiment.

After the NodeB receives the physical layer measurement result report, the NodeB may determines, according to information in the physical layer measurement result report, whether a downlink transmission mode is switched to mode 2 or mode 3. To avoid a ping-pong effect, a hysteresis mechanism may be further introduced.

That the information about the RSCP is included in the physical layer measurement result report is used as an example. Assuming that an initial transmission mode of the UE is mode 1, a determining criterion for determining whether the downlink transmission mode is switched to mode 2 or mode 3 is as follows:

a condition for switching to mode 2 or mode 3 from mode 1 is: at least one monitored node satisfies a first inequality:

|a measured value of an RSCP of the monitored node−an RSCP value of a current node|≦3−H1, where H1 is a first hysteresis parameter; and

a condition for switching to mode 1 from mode 2 or mode 3 is: at least one monitored node satisfies a second inequality:

|a measured value of an RSCP of a currently selected first node−an RSCP value of a currently selected second node|≧3+H2, where H2 is a second hysteresis parameter.

It should be noted that H1 and H2 may be equal or unequal, which is not limited in this embodiment.

The NodeB may send a mode switching indication by using an HS-SCCH according to a transmission mode supported by the UE. If a receiver capability of the UE is supporting only mode 1 and mode 2, and the UE uses an OLTD in mode 2, when the NodeB performs downlink transmission mode switching, the NodeB does not need to send the mode switching indication to the UE. If the UE uses a closed loop transmit diversity (Closed Loop Transmit Diversity, CLTD for short) in mode 2, when the NodeB performs downlink transmission mode switching, the NodeB needs to send the mode switching indication to the UE.

If a receiver capability of the UE is supporting mode 1, mode 2 and mode 3, when the NodeB sends the mode switching indication to the UE, the mode switching indication not only needs to include information about a downlink transmission mode, but also needs to include information about a node that sends downlink data, that is, indicates, to the UE, the NodeB uses which nodes to send the downlink data to the UE, to facilitate correct reception by the UE.

Assuming that measurement results reported by the UE include measurement results of four nodes at most, and when downlink data transmission is implemented, at most two nodes can simultaneously send data to the UE, in mode 3, C₄²=6 different combinations of nodes sending downlink data need to be indicated, and at least three bits (bits) are required to indicate the transmission mode.

For example, in a scenario in which a receiver capability of the UE is supporting all of mode 1, mode 2 and mode 3, a mapping relationship between a bit mode used by the mode switching indication and a downlink transmission mode is shown in Table 2 and Table 3:

TABLE 2
UE uses OLTD in mode 2

| | Downlink transmission |
|---|---|
| Bit mode | mode |
| 000 | mode 1, mode 2 |
| XXX | mode 3 + Node X + Node Y |

The three bits 000 are used for indicating to the UE that the downlink transmission mode is to be switched to mode 1 or mode 2. Any three bits except 000 are used for indicating to the UE that the downlink transmission mode is to be switched to mode 3, and indicates to the UE that the NodeB will use the node X and the node Y to send downlink data, to facilitate correct reception by the UE.

TABLE 3
UE uses CLTD in mode 2

| | Downlink transmission |
|---|---|
| Bit mode | mode |
| 0000 | mode 1 |
| XXXX | mode 2 + Node X + Node Y |
| YYYY | mode 3 + Node X + Node Y |

The four bits 0000 are used for indicating to the UE that the downlink transmission mode is to be switched to mode 1. The four bits XXXX are used for indicating to the UE that the downlink transmission mode is to be switched to mode 2, and indicates to the UE that the NodeB will use the node X and the node Y to send downlink data to the UE. The four bits YYYY are used for indicating to the UE that the downlink transmission mode is to be switched to mode 3, and indicates to the UE that the NodeB will use the node X and the node Y to send downlink data to the UE, to facilitate correct reception by the UE.

In a scenario in which a receiver capability of the UE is supporting only mode 1 and mode 2, a mapping relationship between a bit mode used by the mode switching indication and a downlink transmission mode is shown in Table 4:

TABLE 4
UE uses CLTD in mode 2

| | Downlink transmission |
|---|---|
| Bit mode | mode |
| 000 | mode 1 |
| XXX | mode 2 + Node X + Node Y |

The three bits 000 are used for indicating to the UE that the downlink transmission mode is to be switched to mode 1. The three bits XXX except 000 are used for indicating to the UE that the downlink transmission mode is to be switched to mode 2, and indicates to the UE that the NodeB will use the node X and the node Y to send downlink data to the UE.

In the technical solution in this embodiment, UE can trigger a process for downlink transmission mode switching, and mode switching can be completed without higher layer signaling exchange, thereby reducing a latency for downlink transmission mode switching.

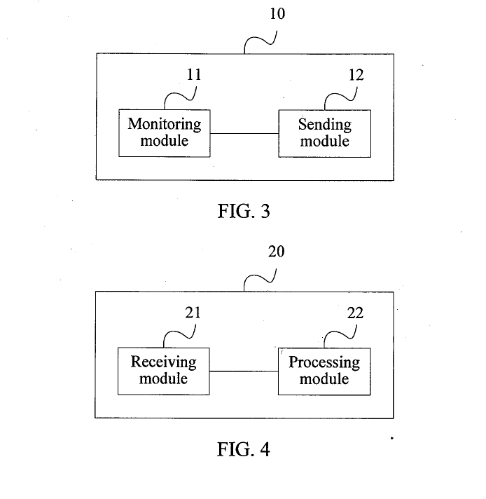

FIG. 3 is a schematic structural diagram of Embodiment 1 of UE according to the present invention. As shown in FIG. 3, the UE 10 provided in this embodiment may specifically include a monitoring module 11 and a sending module 12, where the monitoring module 11 may be configured to monitor pilot signals sent by at least two nodes, where the pilot signals sent by the different nodes are different, and the pilot signals are used for differentiating the at least two nodes; and the sending module 12 may be configured to send a physical layer measurement result report to a NodeB if the UE determines, according to the detected pilot signals, that measurement results of the pilot signals of the at least two nodes meet a preset trigger condition, so that the NodeB performs downlink transmission mode switching.

Further, the UE 10 may further include a receiving module, configured to receive a mode switching indication that is sent by the NodeB by using an HS-SCCH, where the mode switching indication includes information about a downlink transmission mode. Optionally, the mode switching indication further includes information about a node that sends downlink data.

Specifically, the preset trigger condition maybe: the UE detects that a parameter value of the pilot signals sent by the at least two nodes falls within a preset threshold range; or the UE detects that a parameter value of the pilot signals sent by the at least two nodes falls beyond a preset threshold range.

The parameter value of the pilot signals is any one of the following: a strength difference of the pilot signals, a channel quality difference, and a path gain difference. The at least two nodes send the pilot signals in at least one of the following manners: different timeslots, different scrambling codes, and different channelization codes. The physical layer measurement result report includes at least one of the following information: information about a channel quality indicator, information about a path gain, information about Ec/No, and information about a received signal code power. No limitation is set thereto in this embodiment.

The UE in this embodiment can be configured to execute the technical solution in the foregoing method embodiments, and the implementation principles and technical effects thereof are similar, which are not described in detail herein again.

FIG. 4 is a schematic structural diagram of an embodiment of a NodeB according to the present invention. As shown in FIG. 4, the NodeB 20 provided in this embodiment may specifically include a receiving module 21 and a processing module 22, where

the receiving module 21 may be configured to receive a physical layer measurement result report sent by user equipment UE, where the physical layer measurement result report is sent by the UE to the NodeB when the UE determines that measurement results of signals of at least two nodes meet a preset trigger condition; and

the processing module 22 may be configured to perform downlink transmission mode switching according to the physical layer measurement result report.

Further, the NodeB 20 may further include a sending module, configured to send a mode switching indication by using an HS-SCCH, where the mode switching indication is used for indicating to the UE that downlink transmission enters a different transmission mode; and the mode switching indication includes information about a downlink transmission mode. Optionally, the mode switching indication further includes information about a node that sends downlink data.

Specifically, the physical layer measurement result report includes at least one of the following information: information about a channel quality indicator, information about a path gain, information about Ec/No, and information about a received signal code power, which is not limited in this embodiment.

The NodeB in this embodiment can be configured to execute the technical solution in the foregoing method embodiments, and the implementation principles and technical effects thereof are similar, which are not described in detail herein again.

In the several embodiments provided in the present invention, it should be understood that the disclosed apparatus and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, maybe located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated unit maybe implemented in a form of hardware, or maybe implemented in a form of a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) or a processor to perform a part of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

It may be clearly understood by persons skilled in the art that, for the purpose of convenient and brief description, division of the foregoing functional modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing apparatus, reference may be made to a corresponding process in the foregoing method embodiments, and details are not described herein again.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A transmission mode switching method, comprising:
monitoring, by user equipment (UE), pilot signals sent by at least two nodes, wherein the pilot signals sent by the at least two nodes are different, and the pilot signals are used for differentiating the at least two nodes; and
sending, by the UE, a physical layer measurement result report to a base station if the UE determines, according to the detected pilot signals, that measurement results of the pilot signals of the at least two nodes meet a preset trigger condition, so that the base station performs downlink transmission mode switching.

2. The method according to claim 1, wherein after sending, by the UE, a physical layer measurement result report to a base station if the UE determines, according to the detected pilot signals, that measurement results of the pilot signals of the at least two nodes meet a preset trigger condition, the method further comprises:
receiving, by the UE, a mode switching indication sent by the base station by using a downlink high speed-shared control channel (HS-SCCH), wherein the mode switching indication comprises information about a downlink transmission mode.

3. The method according to claim 2, wherein the mode switching indication further comprises information about a node that sends downlink data.

4. The method according to claim 1, wherein the preset trigger condition is:
the UE detects that a parameter value of the pilot signals sent by the at least two nodes falls within a preset threshold range; or
the UE detects that a parameter value of the pilot signals sent by the at least two nodes falls beyond a preset threshold range.

5. The method according to claim 4, wherein the parameter value of the pilot signals is any one of the following: a strength difference of the pilot signals, a channel quality difference, and a path gain difference.

6. The method according to claim 1, wherein the at least two nodes send the pilot signals in at least one of the following manners: different timeslots, different scrambling codes, and different channelization codes.

7. The method according to claim 1, wherein the physical layer measurement result report comprises at least one of the following information: information about a channel quality indicator, information about a path gain, the received energy per chip divided by the power density in the band (Ec/No), and information about a received signal code power.

8. A transmission mode switching method, comprising:
receiving, by abase station, a physical layer measurement result report sent by user equipment (UE), wherein the physical layer measurement result report is sent by the UE to the base station when the UE determines that measurement results of signals of at least two nodes meet a preset trigger condition; and
performing, by the base station, downlink transmission mode switching according to the physical layer measurement result report.

9. The method according to claim 8, wherein after performing, by the base station, downlink transmission mode switching according to the physical layer measurement result report, the method further comprises:
sending, by the base station, a mode switching indication to the UE by using a downlink high speed-shared control channel (HS-SCCH), wherein the mode switching indication is used for indicating to the UE that downlink transmission enters a different transmission mode, and wherein the mode switching indication comprises information about a downlink transmission mode.

10. The method according to claim 9, wherein the mode switching indication further comprises information about a node that sends downlink data.

11. The method according to claim 8, wherein the physical layer measurement result report comprises at least one of the following information: information about a channel quality indicator, information about a path gain, information about the received energy per chip divided by the power density in the band (Ec/No), and information about a received signal code power.

12. User equipment (UE), comprising:
a processor, configured to monitor pilot signals sent by at least two nodes, wherein the pilot signals sent by the at least two nodes are different, and the pilot signals are used for differentiating the at least two nodes; and
a transmitter, configured to send a physical layer measurement result report to a base station if the UE determines, according to the detected pilot signals, that measurement results of the pilot signals of the at least two nodes meet a preset trigger condition, so that the base station performs downlink transmission mode switching.

13. The UE according to claim 12, further comprising:
a receiver, configured to receive a mode switching indication that is sent by the base station by using a downlink high speed-shared control channel (HS-SCCH), wherein the mode switching indication comprises information about a downlink transmission mode.

14. The UE according to claim 13, wherein the mode switching indication further comprises information about a node that sends downlink data.

15. The UE according to claim 12, wherein the preset trigger condition is:
the UE detects that a parameter value of the pilot signals sent by the at least two nodes falls within a preset threshold range; or
the UE detects that a parameter value of the pilot signals sent by the at least two nodes falls beyond a preset threshold range.

16. The UE according to claim 15, wherein the parameter value of the pilot signals is any one of the following: a strength difference of the pilot signals, a channel quality difference, and a path gain difference.

17. The UE according to claim 12, wherein the at least two nodes send the pilot signals in at least one of the following manners:
different timeslots, different scrambling codes, and different channelization codes.

18. The UE according to claim 12, wherein the physical layer measurement result report comprises at least one of the following information: information about a channel quality indicator, information about a path gain, information about the received energy per chip divided by the power density in the band (Ec/No), and information about a received signal code power.

19. A base station, comprising:
a receiver, configured to receive a physical layer measurement result report sent by user equipment (UE), wherein the physical layer measurement result report is sent by the UE to the base station when the UE determines that measurement results of signals of at least two nodes meet a preset trigger condition; and
a processor, configured to perform downlink transmission mode switching according to the physical layer measurement result report.

20. The base station according to claim 19, further comprising:
a transmitter, configured to send a mode switching indication to the UE by using a downlink high speed-shared control channel (HS-SCCH), wherein the mode switching indication is used for indicating to the UE that downlink transmission enters a different transmission mode, and wherein the mode switching indication comprises information about a downlink transmission mode.
